(19) United States
(12) Patent Application Publication
(10) Pub. No.: US 2009/0136628 A1
(43) Pub. Date: May 28, 2009

(54) Produce shaping, apparatus therefor and uses thereof

(76) Inventors: Michael Patrick Hall, Hastings (NZ); Kenneth Barry Davison, Oropitaga (NZ); Marcel Steens, Tauranga (NZ); Stephen Alexander Ham, Papamoa (NZ); Richard Jones Stovell, Drury (NZ)

Correspondence Address: JACOBSON HOLMAN PLLC, 400 SEVENTH STREET N.W., SUITE 600, WASHINGTON, DC, 20004, US

(21) Appl. No.: 10/548,454

(22) PCT Filed: Mar. 9, 2004
(86) PCT No.: PCT/NZ04/00049

§ 371 Date: Nov. 17, 2006

(30) Foreign Application Priority Data
Mar. 12, 2003 (NZ) 524709
Mar. 12, 2003 (NZ) 524710

(51) Int. Cl. A23N 15/00; B65B 55/02; A23B 7/00; A23N 7/02; A23L 1/212

(52) U.S. Cl. 426/106; 426/512; 426/392; 426/324; 426/615; 99/588; 99/593

(57) ABSTRACT

The apparatus and method shaves produce such as carrots to a uniform style capable fo being packaged. The apparatus has shavers arrayed about the rotational axis of, yet carried by, a carousel, each having at least one blade rotatable about its associated rotational axis substantially parallel to but spaced outwardly of the rotational axis of the carousel. A magazine or hopper or robotic fed product stuffer is adapted to drive a produce item for shaving into an indexed shaver for shaving of that produce item as the shaver but not the carousel is drivingly rotated. A product ejection arrangement is to act on the shaven and crowned product whilst the shaver still supports the product to remove the product in a direction opposite its stuffing direction.

### FIELD OF THE INVENTION

The present invention relates to produce shaping apparatus and uses thereof to provide products (being preferably shaped root or bulbous vegetable products typified by but not restricted to derived from carrots, parsnips and beetroot).

The present invention relates to root or bulbous vegetables typified by but not restricted to carrots, parsnips and beetroot.

Frequently growers will encounter a grading regime for their produce which precludes from some market destinations a significant part of their crop. Frequently they also encounter retailer or customer resistance owing a perceived need for ender user preparation (e.g. trimming, etc.). It is to this that the present invention is directed.

The present invention involves or has as an object a procedure whereby produce insofar as appearance, exterior configuration or the like can be modified by a peeling or shaving process (as opposed to abrasive tumbling or erosion) to produce a substantially uniform product capable, if desired, of being sterile packed and sold for use.

The present invention involves a procedure whereby products not up to a standard insofar as appearance, exterior configuration or the like can be modified to produce a substantially uniform product capable of being sterile packed and sold for use. The present invention has as an alternative object apparatus and methods of use of such apparatus useful for shaping products (preferably in a substantially uniform manner) irrespective of whether or not the source material from which the products have been shaped are up to a marketable standard or not.

### BRIEF DESCRIPTION OF THE INVENTION

In a first aspect the present invention consists in apparatus for shaping as products produce items (such as a carrots), said apparatus comprising or including
a carousel having a rotational axis,
a series of produce item shavers arrayed about the rotational axis of, yet carried by, the carousel, each having at least one blade rotatable about its associated rotational axis substantially parallel to but spaced outwardly of the rotational axis of the carousel,
a drive for each produce item shaver to rotate each about its rotational axis,
a carousel rotation and indexing arrangement to rotate the carousel about its rotational axis to serially present stations to the produce shavers,
a magazine or hopper or robotic fed product stuffer to drive a produce item for shaving into an indexed and stuffing stationed shaver for shaving of that produce item as the shaver but not the carousel is drivingly rotated,
a product crowner to act on the recently shaven produce item at a station at which the shaver is indexed, other than the stuffing station, whilst still supporting its shaven product, and
a product ejection arrangement (e.g. a fluid flow) to act on the shaven and crowned product whilst the shaver still supports the product to remove the product in a direction opposite its stuffing direction.

In a further aspect the present invention consists in apparatus for shaping a product (from produce such as a carrot), said apparatus comprising or including
a carousel having a rotational axis,
a series of produce shavers arrayed about the rotational axis of, yet carried by, the carousel, each shaver having at least one blade rotatable about its rotational axis substantially parallel to, but spaced outwardly of, the rotational axis of the carousel,
a drive for each produce shaver to rotate each about its rotational axis,
a carousel rotation and indexing arrangement to rotate the carousel about its rotational axis to serially present machine functions to the produce shavers,
a magazine or hopper or robotic fed product stuffer to drive produce for shaving into an indexed shaver for shaving as the shaver is drivingly rotated,
a product crowner to act on a shaven produce item whilst its shaver is still supporting the shaven produce, and
a product ejection arrangement (e.g. a fluid flow) to act on the shaven and crowned produce whilst the shaver still supports the produce to remove the produce as a shaven and crowned product in a direction opposite its stuffing direction.

In still a further aspect the present invention consists in a method of shaping a product from product (e.g. such as a carrot), said method comprising or including
feeding a feedstock of the produce, one item at a time, longitudinally into a dedicated shaver carried by a carousel and shaping the produce by shaving whilst holding the produce relatively still in the shaver as at least one blade the shaver rotates about the axis of the longitudinal item,
crown shaping a larger end of each shaven produce whilst it is still supported by its shaver, and
ejecting each shaped and crowned product from the shaver.

Preferably each crowing and ejection step for a particular produce item occurs at a different rotational position (e.g. optionally at stations) of the shaver about the rotational axis of the carousel.

Preferably produce item feed into its shaver is under the action of a ram from a magazine or the like.

Preferably the crowning is by a ram supported produce item reliant on rotation of the blade(s) of the shaver relative to the produce (whether the produce itself is cause to rotate by the shaver or the blade is rotated, or both).

Preferably the ejection is under the action of a fluid flow.

Preferably the method is performed substantially as hereinafter described with reference to any one or more of the accompanying drawings.

In still a further aspect the present invention consists in a method of the present invention when performed using apparatus of the present invention.

In another aspect the present invention consists in a method of preparing a root or bulbous vegetable (e.g. carrot, parsnip, beetroot or the like), said method comprising or including
(optionally) pre-sizing vegetables of the same kind to provide a sufficient feedstock thereof (“feedstock form”),
mechanically shaping the feedstock form using apparatus of the present invention to a predetermined product form and product size (“the product form”), and
creating a sterile package that includes the product forms.

Preferably the creation of the sterile package involves both a sterilization step for the shaped product forms as well as the packaging thereof.

Preferably said vegetables are carrots and (i) the pre-sizing is by (preferably by one or both) topping and tailing and/or (ii) the predetermined form and size is to a predetermined length and girth of a simulated carrot form.

Preferably each said product shaver is a substantially conical or frustoconical shaver that performs in a manner similar to a pencil sharpener with the feedstock carrot being stuffed into the shaver to a uniform extent and being so held so as to provide a shaving relativity of rotational movement therein.

Preferably the shaver rotates and the carrot does not, or vice versa.

Preferably a ram drives each feedstock carrot of predetermined length in a predetermined distance into the shaver.

Preferably such a ram feeds a feedstock form from a magazine thereof.

Preferably each shaped carrot is discharged from the shaving apparatus from the larger end thereof under the action of a fluid (e.g. air or water) introduced from the other end.

In another aspect the present invention consists in a method of providing a carrot product which is a predetermined carrot simulating form and a substantially predetermined reduced size, said method comprising or including
(optionally) cutting a carrot to length to provide a feedstock carrot of a predetermined length and a girth beyond that desired,
feeding each such feedstock carrot into a shaver of apparatus of the present invention, said feeding being a mechanical feed of the carrot into the shaver and shaping the carrot,
crown shaping of the still shaver supported carrot using a product crowner, and
removing the thus sized and shaped carrot form from such shaving apparatus prior to the
   infeed of a subsequent feedstock carrot there into.

Preferably said method includes in addition sterilizing and packing such carrot forms in a sterile pack.

In some forms of the present invention a preservative, composition, solution, etc. can be associated with the carrot forms in the pack.

In yet a further aspect the present invention consists in a carrot or other produce of a shaped form that is the result of the use of apparatus or a method of the present invention.

The present invention also consists in any shaped foodstuff that has been shaped using a method or apparatus of the present invention.

In another aspect the present invention consists in a method of preparing a root or bulbous vegetable (e.g. carrot, parsnip, beetroot or the like), said method comprising or including
pre-sizing vegetables of the same kind to provide a sufficient feedstock thereof (“feedstock form”),
mechanically shaping the feedstock form to a predetermined product form and product size (“the product form”), and
creating a sterile package that includes the product forms.

Preferably the creation of the sterile package involves both a sterilization step for the shaped product forms as well as the packaging thereof.

Preferably said vegetables are carrots and (i) the pre-sizing is by (preferably both) topping and tailing and/or (ii) the predetermined form and size is to a predetermined length and girth of a simulated carrot form.

Preferably step (i) and/or step (ii) are (is) machine automated.

Preferably the shaping step is performed by serially presenting a number of the pre-sized feedstock carrots to a shaping apparatus.

Preferably said shaping apparatus is a substantially conical or frustoconical shaver that performs in a manner similar to a pencil sharpener with the feedstock carrot being machine feed into the shaver to a uniform extent and being machine held so as to provide a shaving relativity of rotational movement therein.

Preferably where a top and tailed carrot or the like is over girth for the shaver it has been either excluded or trimmed in its girth to allow entry fully into the shaver.

Preferably the shaver rotates and the carrot does not, or vice versa.

Preferably a ram drives each feedstock carrot of predetermined length in a predetermined distance into the shaver.

Preferably such a ram feeds a feedstock form from a magazine thereof.

Preferably each shaped carrot is discharged from the shaving apparatus from the larger end thereof under the action of air introduced from the other end.

In another aspect the present invention consists in a method of providing a carrot product which is a predetermined carrot simulating form and a substantially predetermined reduced size, said method comprising or including
cutting a carrot to length to provide a feedstock carrot of a predetermined length and a girth beyond that desired, and
feeding each such feedstock carrot into a shaver, said feeding being a mechanical feed of the known length feedstock carrot a predetermined distance into the shaving apparatus and
removing the thus sized and shaped carrot form from such shaving apparatus prior to the infeed of a subsequent feedstock carrot there into.

Preferably said method includes in addition sterilizing and packing such carrot forms in a sterile pack.

In some forms of the present invention a preservative, composition, solution, etc. can be associated with the carrot forms in the pack.

In yet a further aspect the present invention consists in a carrot form that is the result of topping and tailing a carrot and shaving the truncated carrot form to a carrot simulating form of lesser girth.

In a further aspect the present invention consists in a sterile packed carrot form being a reduced size and girth carrot simulating form as previously mentioned.

The present invention also consists in any shaped foodstuff that has been shaped using a method or apparatus of the present invention.

### BRIEF DESCRIPTION OF THE DRAWINGS

A preferred form of the present invention will now be described with reference to the accompanying drawings in which

FIG. 1 shows in broken outline the perimeter of a shrink wrap sterile packaging pack in which a few products in accordance with the present invention have been packed, such products each being a reduced form of a carrot or the like product larger form,

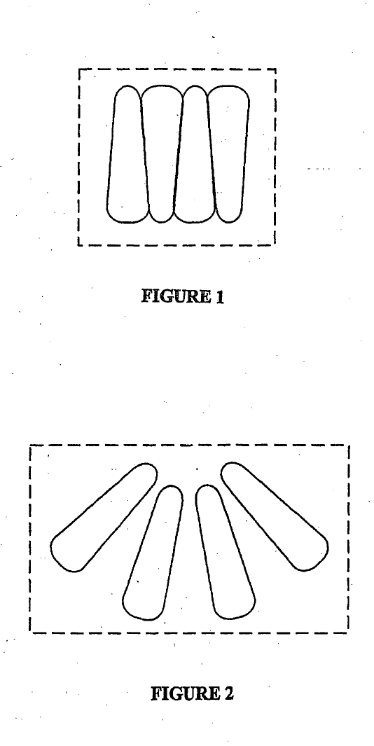

FIG. 2 shows an alternative array in a pack,

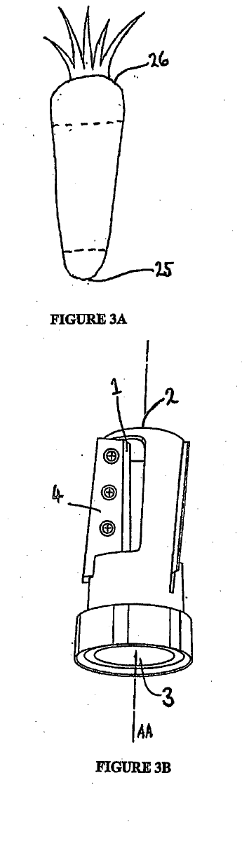

FIG. 3A shows a typical vegetable form where removal of the distal ends is conducted at the dotted lines.

FIG. 3B shows a preferred shaver in accordance with the present invention showing the generally conical form thereof which complements the angled cutter thereof,

FIGS. 4 to 6 show preferred apparatus in accordance with the present invention, the depictions being substantially similar but allowing an explanation of the sequencing of operation as the carousel rotates thereby carrying from one functional station to another the carrot or other produce carried by its shaver.

FIG. 7 shows a preferred flow diagram of the present invention,

FIG. 8A through 8E shows a preferred method of operation of apparatus in accordance with the present invention,

FIG. 9 shows a perspective view of apparatus and operation in accordance with the present invention,

FIG. 10 shows another perspective view of the apparatus in operation in accordance with the present invention,

FIG. 11 shows a perspective view of the ram unit (left) in an engageable position with the carousel (right) in accordance with the current invention.

### DETAILED DESCRIPTION OF THE INVENTION

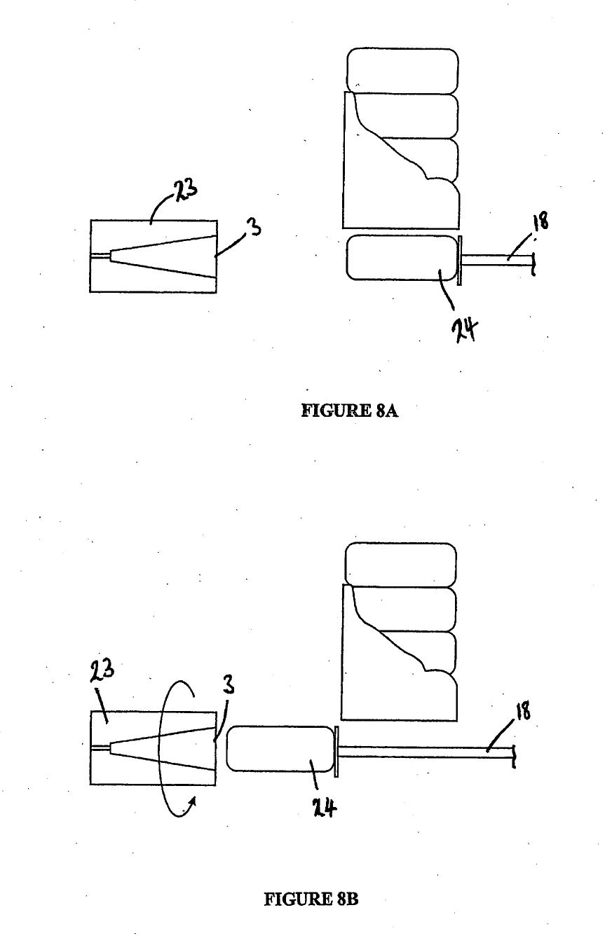

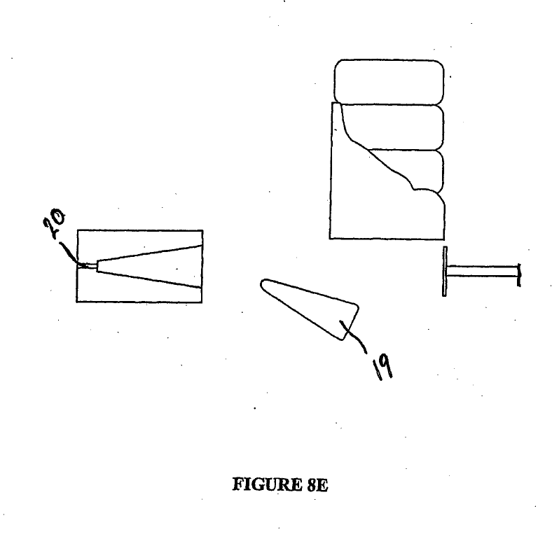

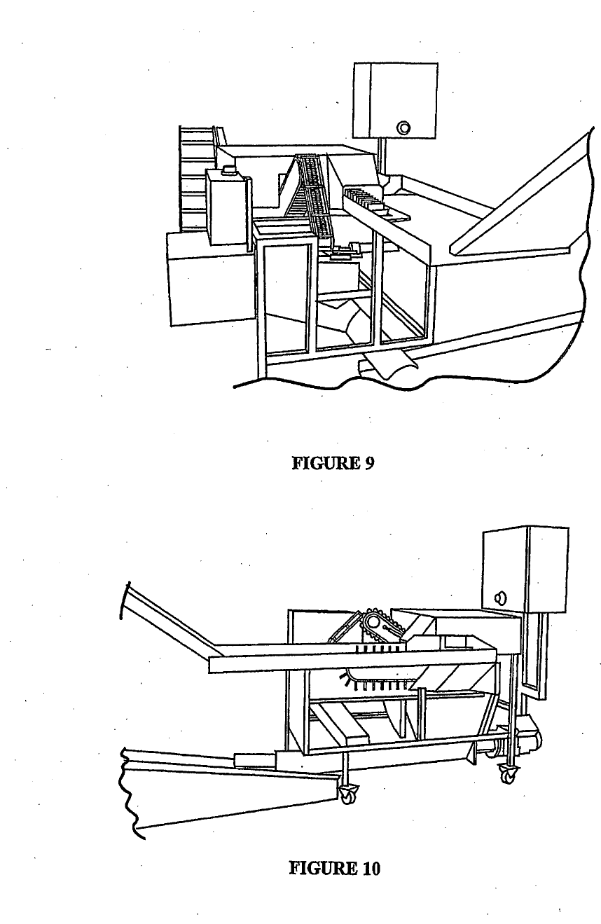

In the preferred sequence of events follows those described within the flow chart in FIG. 7 and shown schematically in perspective views of the apparatus carrying out the operation in accordance with the current invention in FIG. 9 and FIG. 10.

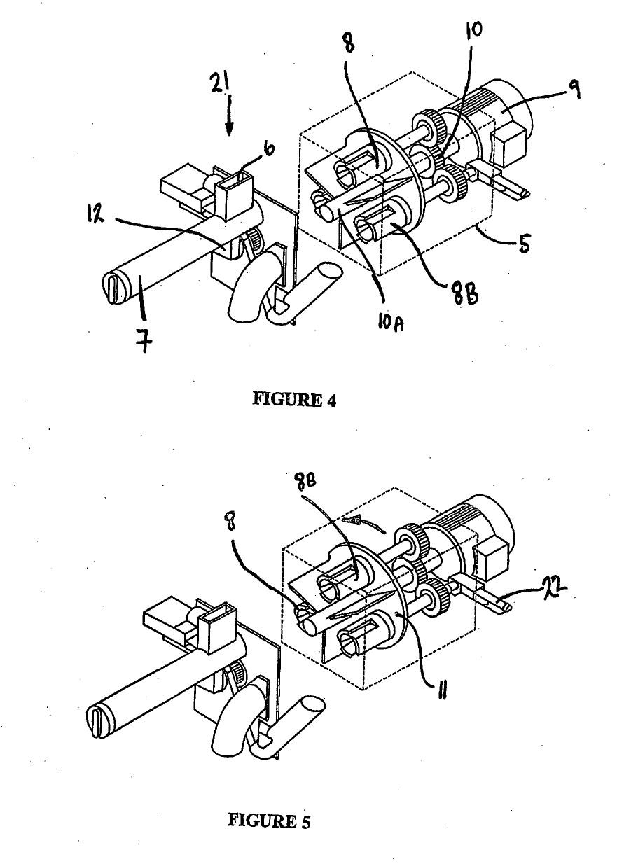

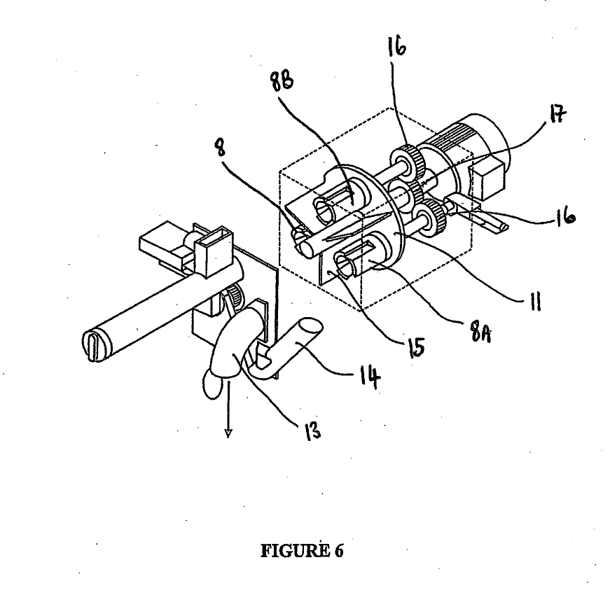

In the preferred form of the present invention a magazine feed of (optionally topped and tailed) carrots (could be other foodstuffs however) are serially feed by a ram into a shaver of the kind as shown in FIG. 3B.

Preferably the carrot form has preferably been topped and tailed (for example, to a length of, for example, 87 mm) in accordance with FIG. 3A and where over size as far as girth is concerned, has been subjected to some reduction in its size either by abrasion, cutting, trimming or the like.

As can be seen from the arrangement of FIG. 3B the generally cylindrical form of shaver has a blade 1 inclined relative to the rotational axis shown by the broken line thereby deriving for a produce item such as a carrot a substantially frustoconical form and preferably a non pointed smaller end at the end of the frustum.

As can be seen from FIG. 3A, the carrots have their distal end region 25 as well as a crowned end region 26. The crowning at 26 preferably has the effect of removing any vestige of the stalk as shown by the dotted lines of FIG. 3A.

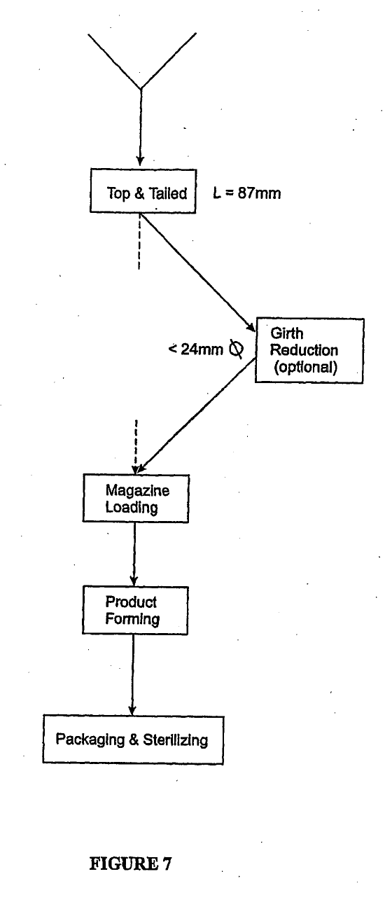

FIG. 4 shows in an exploded form, (i.e. exploded to the extent that subassembly 21 is spaced away from the zone of the broken outline 5 (for clarity of explanation)) of apparatus in accordance with the present invention.

The broken away region 21 includes a carrot feeding chute 6 capable of being arranged whereby a stuffer ram (not shown) but outwardly drivable from within the tube 7 serially acts on the carrots and can stuff each carrot into an indexed shaver 8, being a shaver substantially as described or some variant of that described with respect to FIG. 3B.

Each shaver 8, 8A and 8B is itself rotatable about its own axis, (i.e. axis AA as shown in FIG. 3) under the action of an electric motor 9 which with its geared shaft 10 has the capability (through gears 16 and 17 meshing) when desired of continuously or intermittently rotating its shaver 8, 8A and/or 8B as the occasion requires. The shaft end 10A is preferably journalled in part of the assembly 4.

The progression of the carousel 11 is in the arrowed direction shown in FIG. 5 such that from the indexed and stationed relationship between the stuffer tube 7 and the shaver 8, a carrot form is shaven by rotation of the shaver 8 prior to its place at that station being taken by shaver 8B.

At this time shaver 8 is aligned with crowning apparatus being a cutter or former (not shown) shown generally by the region 12 which has the effect (whether as the crowning cutter or former rotates itself and/or the shaver 8A rotates about its axis) of crowning each carrot at the end 3.

Thereafter, further rotation of the carousel of the apparatus moves the shaver 8 to the condition shown in FIG. 6 whereupon a water supply entering at 22 will have the effect of blasting a carrot that has been shaped and crowned out of its support in shaver 8 and out of a discharge outlet 13.

Actual rotation of the carousel 11 itself can be under the action of a ram presenting out of the tube 14 which will bear successively, as far as stroke is concerned, on the vane series 15.

It can be seen therefore that, if desired, the motor 9 can be continuously or continually rotated so as to drivingly rotate the shavers (as and when desired) whilst, independently of any such positive drive, there is still some prospect of shaver drive as a result of progression of gears 16 about gear 17.

The carousel 11 with its vanes 15 can be progressively yet intermittently be moved from one indexing condition to another indexing condition to allow serially (A) stuffing and shaving, (B) crowning and (C) ejection.

The control of the feed of the carrots to a stage where they might be hopper feed into magazines each for a shaver of the kind depicted in FIG. 3B can be any suitable apparatus and may include one or more handling types of apparatus such as, for example, disclosed in Grimmway Enterprises Inc. PCT/US00/10449 (published as WO 00/64288).

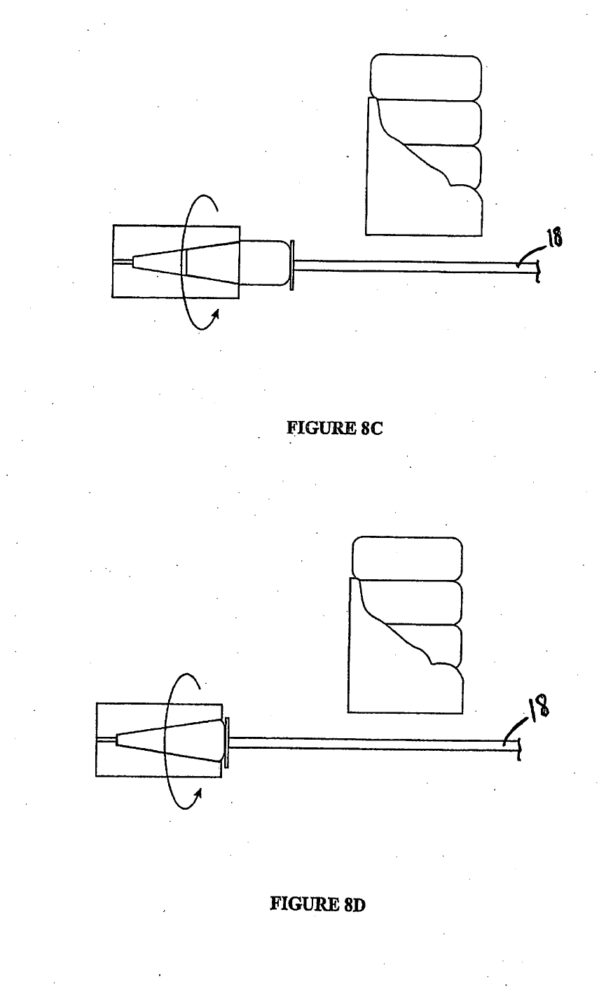

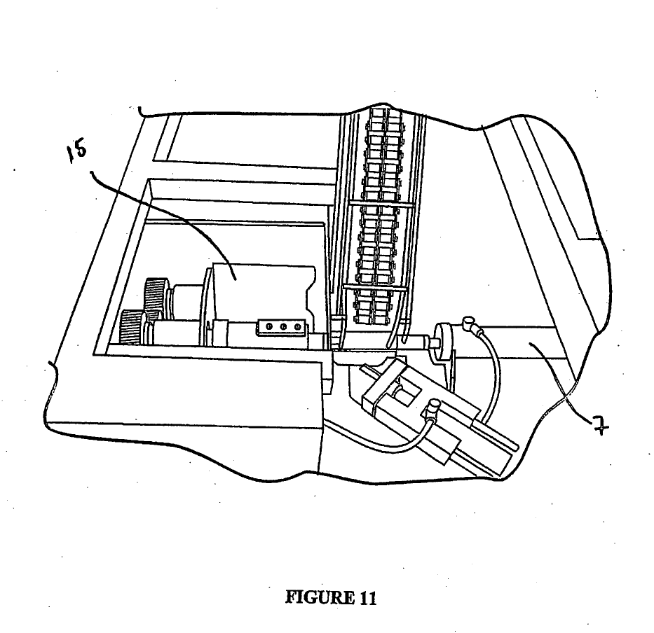

In operation, preferably, the cutter 2 with its conical passageway 3 and angled cutter 4 is adapted to receive a pre-sized carrot form as shown in FIGS. 8A, 8B, 8C and 8D with the ram (any suitable carrot engaging configuration) 18 having the ability to stabilize the carrot whilst the shaver 23 rotates or alternatively to rotate the pre-sized carrot form 24 as the shaving apparatus 23 is kept stationery, or (less preferred) some combination of both. The carousel unit 15 and ram 7 are shown schematically in FIG. 11.

As can be seen by having a control on the feed of the ram 18 to the condition as shown in FIG. 8D a uniform product form results owing to a uniform length of pre-sized carrot having been presented into the shaving apparatus.

Once and/or as the ram 5 retracts air or another fluid can ensure that the formed carrot 19 is ejected from the passageway 3, such air or fluid being blasted in, for example, through a passageway or duct such as 20.

Persons skilled in the art will appreciate how the present invention enables a reject carrot to be topped and tailed and shaped to an appetizing form since generally it is the exterior of the carrot that is blemished.

Such uniform carrot forms will find application as a snack and/or as an embellishment for use in food preparation and/or cooking.

1-36. (canceled)

37: Apparatus for shaping as products produce items (such as root or bulbous vegetables such as carrots), said apparatus comprising or including
a carousel having a rotational axis,
a series of produce item shavers arrayed about the rotational axis of, yet carried by, the carousel, each having at least one blade rotatable about its associated rotational axis substantially parallel to but spaced outwardly of the rotational axis of the carousel,
a drive for each produce item shaver to rotate each about its rotational axis,
a carousel rotation and indexing arrangement to rotate the carousel about its rotational axis to serially present stations to the produce shavers, and
a magazine or hopper or robotic fed product stuffer to drive a produce item for shaving into an indexed and stuffing stationed shaver for shaving of that produce item as the shaver but not the carousel is drivingly rotated.

38: The apparatus of claim 37 wherein a product crowner acts on the recently shaven produce item at a station at which the shaver is indexed, other than the stuffing station, whilst still supporting its shaven product.

39: The apparatus of claim 38 wherein a product ejection arrangement acts on the shaven and crowned product whilst the shaver still supports the product to remove the product in a direction opposite its stuffing direction.

40: The apparatus of claim 39 wherein the product ejection arrangement uses a fluid flow or is a fluid flow.

41: Apparatus for shaping a product (from produce such as a carrot), said apparatus comprising or including
a carousel having a rotational axis,
a series of produce shavers arrayed about the rotational axis of, yet carried by, the carousel, each shaver having at least one blade rotatable about its rotational axis substantially parallel to, but spaced outwardly of, the rotational axis of the carousel,
a drive for each produce shaver to rotate each about its rotational axis,
a carousel rotation and indexing arrangement to rotate the carousel about its rotational axis to serially present machine functions to the produce shavers, and
a magazine or hopper or robotic fed product stuffer to drive produce for shaving into an indexed shaver for shaving as the shaver is drivingly rotated.

42: The apparatus of claim 41 wherein a product crowner acts on a shaven produce item whilst its shaver is still supporting the shaven produce.

43: The apparatus of claim 42 wherein a product ejection arrangement (e.g. a fluid flow) acts on the shaven and crowned produce whilst the shaver still supports the produce to remove the produce as a shaven and crowned product in a direction opposite its stuffing direction.

44: A method of shaping a product from product (e.g. such as a carrot), said method comprising or including
feeding a feedstock of the produce, one item at a time, longitudinally into a dedicated shaver carried by a carousel and shaping the produce by shaving whilst holding the produce relatively still in the shaver as at least one blade the shaver rotates about the axis of the longitudinal item.

45: The method of claim 44 further comprising or including crown shaping a larger end of each shaven produce whilst it is still supported by its shaver.

46: The method of claim 45 further comprising or including ejecting each shaped and crowned product from the shaver.

47: The method of claim 44 wherein each crowning and ejection step for a particular produce item occurs at a different rotational position (e.g. optionally at stations) of the shaver about the rotational axis of the carousel.

48: The method of claim 44 wherein the produce item feed into its shaver from a magazine or hopper under the action of a ram.

49: The method of claim 44 wherein the crowning is by a ram supported produce item reliant on rotation of the blade(s) of the shaver relative to the produce (whether the produce itself is cause to rotate by the shaver or the blade is rotated, or both).

50: The method of claim 46 wherein the ejection is under the action of a fluid flow.

51: The method of preparing a root or bulbous vegetable (e.g. carrot, parsnip, beetroot or the like), said method comprising or including
mechanically shaping a vegetable feedstock form using an apparatus of claim 37 to a predetermined product form and product size (“the product form”), and
creating a sterile package that includes the product forms.

52: The method of claim 51 further comprising or including the step of pre-sizing vegetables of the same kind to provide a sufficient feedstock thereof (“feedstock form”).

53: The method of claim 51 wherein the creation of the sterile package involves both a sterilization step for the shaped product forms as well as the packaging thereof.

54: The method of claim 51 wherein said vegetables are carrots and (i) the pre-sizing is by (preferably by one or both) topping and tailing and/or (ii) the predetermined form and size is to a predetermined length and girth of a simulated carrot form.

55: The method of claim 51 wherein each said product shaver is a substantially conical or frustoconical shaver that performs in a manner similar to a pencil sharpener with the feedstock carrot being stuffed into the shaver to a uniform extent and being so held so as to provide a shaving relativity of rotational movement therein.

56: The method of claim 55 wherein the shaver rotates and the carrot does not, or vice versa.

57: The method of claim 51 wherein a ram drives each feedstock carrot of predetermined length in a predetermined distance into the shaver.

58: The method of claim 57 wherein said ram feeds a feedstock form from a magazine or hopper thereof.

59: The method of claim 51 wherein each shaped carrot is discharged from the shaving apparatus from the larger end thereof under the action of a fluid (e.g. air or water) introduced from the other end.

60: The method of providing a carrot product which is a predetermined carrot simulating form and a substantially predetermined reduced size, said method comprising or including
feeding a feedstock carrot into an apparatus of claim 37, said feeding being a mechanical feed of the carrot into the apparatus and shaping the carrot, and
crown shaping of the still apparatus supported carrot using a product crowner, and removing the thus sized and shaped carrot form from such apparatus prior to the infeed of a subsequent feedstock carrot there into.

61: The method as claimed in claim 60 comprising or including cutting the carrot to length to provide a feedstock carrot of a predetermined length and a girth beyond that desired.

62: The method of claim 60 which includes in addition sterilizing and packing such carrot forms in a sterile pack.

63: A method of preparing a root or bulbous vegetable (e.g. carrot, parsnip, beetroot or the like), said method comprising or including
pre-sizing vegetables of the same kind to provide a sufficient feedstock thereof (“feedstock form”),
mechanically shaping the feedstock form to a predetermined product form and product size (“the product form”) using a shaver rotatable about an axis of the vegetable, and
creating a sterile package that includes the product forms.

64: The method of claim 63 wherein the creation of the sterile package involves both a sterilization step for the shaped product forms as well as the packaging thereof.

65: The method of claim 63 wherein said vegetables are carrots and (i) the pre-sizing is by (preferably both) topping and tailing and/or (ii) the predetermined form and size is to a predetermined length and girth of a simulated carrot form.

66: The method of claim 65 wherein step (i) and/or step (ii) are (is) machine automated.

67: The method of claim 65 wherein the shaping step is performed by serially presenting a number of the pre-sized feedstock carrots to a shaping apparatus.

68: The method of claim 67 wherein said shaping apparatus is a substantially conical or frustoconical shaver that performs in a manner similar to a pencil sharpener with the feedstock carrot being machine feed into the shaver to a uniform extent and being machine held so as to provide a shaving relativity of rotational movement therein.

69: The method of claim 68 where any over girth carrot for the shaver is either excluded or trimmed in its girth to allow entry fully into the shaver.

70: The method of claim 68 wherein the shaver rotates and the carrot does not, or vice versa.

71: The method of claim 70 wherein a ram drives each feedstock carrot of predetermined length in a predetermined distance into the shaver.

72: The method of claim 71 wherein said ram feeds a feedstock form from a magazine thereof.

73: The method of claim 68 wherein each shaped carrot is discharged from the shaving apparatus from the larger end thereof under the action of air or other fluid introduced from the other end.

74: A method of providing a carrot product which is a predetermined carrot simulating form and a substantially predetermined reduced size, said method comprising or including
cutting a carrot to length to provide a feedstock carrot of a predetermined length and a girth beyond that desired, and
feeding each such feedstock carrot into a shaver having at least one blade which rotates about an axis of the feedstock carrot, said feeding being a mechanical feed of the known length feedstock carrot a predetermined distance into the shaving apparatus and
removing the thus sized and shaped carrot form from such shaving apparatus prior to the infeed of a subsequent feedstock carrot there into.

75: The method of claim 74 which includes in addition sterilizing and packing such carrot forms in a sterile pack.

76: The method of claim 75 wherein a preservative, composition, solution, etc. can be associated with the carrot forms in the pack.

77: A carrot form that is the result of topping and tailing a carrot and shaving the truncated carrot form to a carrot simulating form of lesser girth using an apparatus of claim 37.

78: A sterile packed carrot form being a reduced size and girth carrot simulating form using an apparatus of claim 37.

79: Any shaped foodstuff that has been shaped using a method of claim 39.
